(19) United States
(12) Patent Application Publication
(10) Pub. No.: US 2008/0129461 A1
(43) Pub. Date: Jun. 5, 2008

(54) Radio Frequency Identification Reader and Method of Operating the Same

(76) Inventor: Thomas C. Abraham, Dallas, TX (US)

Correspondence Address: SLATER & MATSIL, L.L.P., 17950 PRESTON RD, SUITE 1000, DALLAS, TX, 75252-5793, US

(21) Appl. No.: 11/949,653

(22) Filed: Dec. 3, 2007

Related U.S. Application Data
(60) Provisional application No. 60/872,165, filed on Dec. 1, 2006.

(51) Int. Cl. H04Q 5/22

(52) U.S. Cl. 340/10.1

(57) ABSTRACT

A radio frequency identification (RFID) reader, system and method of operating the same. In one embodiment, the RFID reader includes a transmitter/receiver configured to detect a signal representing an RFID tag and a processor configured to compare a delta index from the signal to a threshold to determine when the RFID tag is moving. In another aspect, the present invention provides a method of operating an RFID tag including detecting a signal representing an RFID tag and comparing a delta index from the signal to a threshold to determine when the RFID tag is moving.

This application claims the benefit of U.S. Provisional Application No. 60/872,165, entitled “RFID Systems,” filed on Dec. 1, 2006, which application is incorporated herein by reference.

### TECHNICAL FIELD

The present invention is directed, in general, to radio frequency identification (“RFID”) systems and, in particular, to an RFID reader, system and method of operating the same.

### BACKGROUND

While the core technologies that support radio frequency identification (“RFID”) systems have been around for some time, the applications that drive the use thereof have been slow to market. The aforementioned trend has been turning in an impressive fashion as the size and cost of the RFID tags has decreased and the sensitivity of RFID readers has increased. Moreover, the market forces, especially with respect to the supply chain in the retail industry, are pulling the RFID technologies into the mainstream and literally onto the shelves.

In accordance with logistics and supply chain applications, there are complexities in these environments that are challenging for obtaining data from RFID readers and tags. For example, one of the benefits of radio frequency identification is that it does not require a line of sight (“LOS”) read, and it will read most things within its reach. This can, however, be a double-edged sword.

Oftentimes, the RFID reader will detect RFID tags that are not of interest in the periphery of the RFID reader's lobe (detection range). So, as an example, if an operator is loading a pallet of RFID tagged products into a trailer for shipment, the reads of interest would be the pallet in motion (being loaded), and not any static (non-moving) RFID tagged products that may be located near the RFID reader at the time of loading. Thus, it would be beneficial for an RFID system to reduce the “uninteresting” or extraneous reads so that the resulting read data may be processed more quickly and easily.

As mentioned above, the RFID readers read most things in their lobe (i.e., the range and angle of detection as determined by RFID reader and antenna characteristics) or general vicinity. The size of this lobe may vary depending on many variables including the frequency employed and power levels radiated from the RFID reader's antenna(s). Additionally, the Federal Communication Commission (“FCC”) regulates a maximum power level by frequency class in the United States.

As stated above, the benefit of radio frequency identification is that it can be read without line of sight constraints. This benefit is tempered with the constraint that the operational process may not always want to read everything possible. While the RFID readers already have some mechanisms to reduce these additional or uninteresting reads such as digital and inline attenuation (effectively weakening the power to reduce the size of the lobe), additional methods are often necessary to reduce the number of extraneous reads that the RFID reader or host software application processes, and these methods are often ineffective or only partially effective. Attenuation, though one of the more effective techniques currently employed, can often lead to undesirable read performance impact that is unacceptable to the interesting or effective reads.

Of particular interest are the applications wherein the RFID readers are detecting RFID tags located on products that are moving. Accordingly, what is needed in the art is an RFID system that detects an RFID tag located on a product that is moving and reduces reads associated with extraneous RFID tags without using expensive motion sensors and the like.

### SUMMARY OF THE INVENTION

These and other problems are generally solved or circumvented, and technical advantages are generally achieved, by advantageous embodiments of the present invention that include a radio frequency identification (RFID) reader, system and method of operating the same. In one embodiment, the RFID reader includes a transmitter/receiver configured to detect a signal representing an RFID tag and a processor configured to compare a delta index from the signal to a threshold to determine when the RFID tag is moving. In another aspect, the present invention provides a method of operating an RFID tag including detecting a signal representing an RFID tag and comparing a delta index from the signal to a threshold to determine when the RFID tag is moving.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a system level diagram of an embodiment of an RFID system constructed according to the principles of the present invention;

FIG. 2 illustrates a block diagram of an embodiment of an RFID tag constructed according to the principles of the present invention;

FIGS. 3 to 6 illustrate diagrams demonstrating exemplary principles of RFID systems in accordance with the principles of the present invention;

FIG. 7 illustrates a block diagram of an embodiment of an RFID reader in communication with an RFID tag according to the principles of the present invention;

FIG. 8 illustrates a graph of an exemplary read strength response of an RFID tag moving through an RFID reader/antenna field in accordance with the principles of the present invention;

FIG. 9 illustrates a graph of an exemplary read strength response of an RFID tag moving through and stationary RFID tags in an RFID reader/antenna field in accordance with the principles of the present invention;

FIG. 10 illustrates a graph demonstrating changes in read strength for a sample RFID tag in motion in accordance with the principles of the present invention;

FIG. 11 illustrates a graph superimposing static RFID tag changes in RSSI with a first derivative of an RFID tag in motion in accordance with the principles of the present invention; and

FIGS. 12 and 13 illustrate graphs of an exemplary read strength verses time for an RFID tag having a low RSSI and a high RSSI with a radio frequency obstruction in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Unless otherwise provided, like designators for devices employed in different embodiments illustrated and described herein do not necessarily mean that the similarly designated devices are constructed in the same manner or operate in the same way. The present invention will be described with respect to an exemplary embodiment in a specific context, namely, an RFID system including subsystems that address reading RFID tags under stationary and moving or non-static conditions. While the exemplary embodiments are described with respect to an RFID system under stationary and non-static conditions, those skilled in the art should understand that the principles of the present invention are applicable to any application for the RFID system.

The RFID system addresses the RFID tag motion detection problem by utilizing both signal processing and physical attributes. Based on the law of conservation of energy, the amount of energy with which the RFID tags may respond to the RFID reader is finite. Coincidentally, the amount of energy is reduced based on the read distance from the RFID reader's antenna(s) (it is reasonably estimated as 1/R² each way in space where R is the distance from the RFID reader to the RFID tag). So, the distance from the antenna can be approximated based on the amount of energy received from the RFID tag. Additionally, the returned signal can be processed for other motion reliant attributes. The RFID system utilizes the magnitude of and changes in delta indices such as the received signal strength indication (“RSSI”), and it may also use reads per second or any other read strength indication equivalent to determine if an RFID tag is moving (changes in distance with respect to changes in time). The present invention also applies to other techniques such as dynamic background sensing, dynamic threshold setting, and near real time techniques to enhance the sensitivity of detection where appropriate.

The RFID tags that are not moving and are read by the RFID reader will have slightly varying delta indices such as the RSSI values, but they will be minor when compared to that of the RSSI values of RFID tags in motion. Therefore, the RSSI values for RFID tags that are moving will exceed a threshold that is above the normal variance of RSSI values for static (non-moving or stationary) RFID tags and be differentiated from those stationary RFID tags. This threshold can be determined in several ways. In one embodiment, the threshold is pre-selected and fixed. In another embodiment, however, the RFID system can also sense background levels and use this to define and automatically set a dynamic threshold, preferably in real time. In yet another embodiment, techniques can be made available to a human operator to manually and externally set a threshold. In yet another embodiment, the externally determined threshold can be defined by other external but automatic or semi-automatic techniques. Those skilled in the art, however, understand that the RFID system may employ any techniques to address the aforementioned problem and still fall within the broad scope of the present invention.

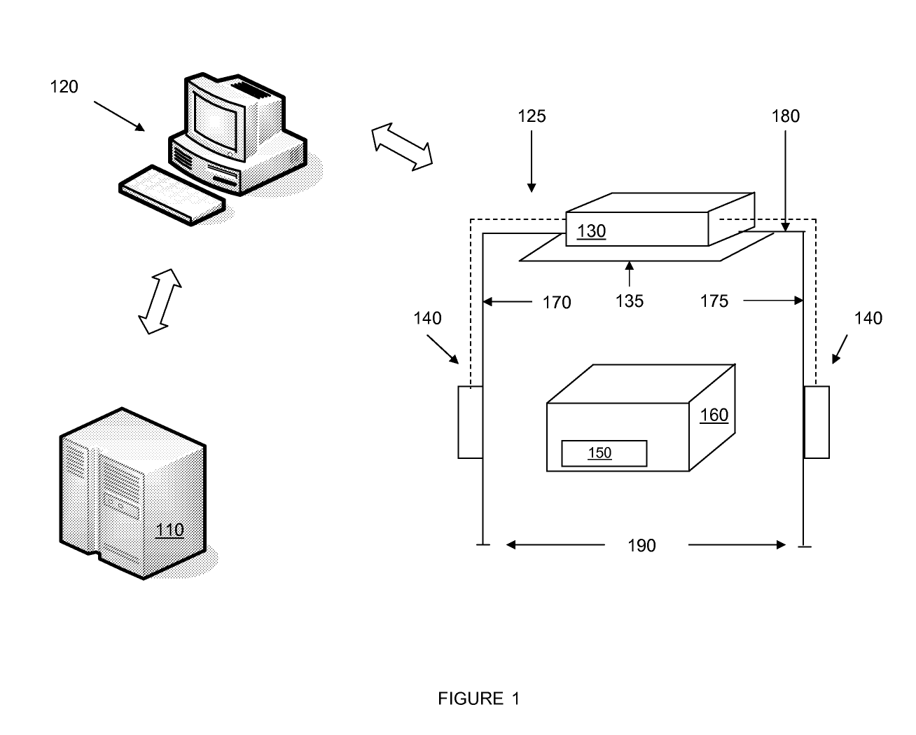

Referring initially to FIG. 1, illustrated is a system level diagram of an embodiment of an RFID system constructed according to the principles of the present invention. The RFID system includes a server 110, a computer system 120, and an RFID portal 125 including an RFID reader 130 located on a plate (e.g., an overhead plate) 135 with antennas (designated 140). The computer system 120 (in connection with the server 110) directs the RFID reader 130 to read RFID tag(s) 150 located on a product or host material 160. The RFID portal 125 includes first and second vertical stanchions 170, 175 formed from telescopic segments configured to adjust a height thereof The RFID portal 125 also includes a horizontal stanchion 180 formed from telescopic segments to form an adjustable horizontal crossbar between the first and second vertical stanchions 170, 175. Each of the vertical stanchions 170, 175 include mount plate footings 190 at a base thereof.

While a single product 160 is illustrated herein, those skilled in the art should understand that the product conceptually may also represent multiple products. In addition, the communication links between respective systems in the RFID system may be wired or wireless communication paths to facilitate the transmission of information therebetween. For a better understanding of communication theory, see the following references “Introduction to Spread Spectrum Communications,” by Roger L. Peterson, et al., Prentice Hall, Inc. (1995), “Modern Communications and Spread Spectrum,” by George R. Cooper, et al., McGraw-Hill Books, Inc. (1986), “An Introduction to Statistical Communication Theory,” by John B. Thomas, published by John Wiley & Sons, Ltd. (1995), “Wireless Communications, Principles and Practice,” by Theodore S. Rappaport, published by Prentice Hall, Inc. (1996), “The Comprehensive Guide to Wireless Technologies,” by Lawrence Harte, et al., published by APDG Publishing (1998), “Introduction to Wireless Local Loop,” by William Webb, published by Artech Home Publishers (1998), and “The Mobile Communications Handbook,” by Jerry D. Gibson, published by CRC Press in cooperation with IEEE Press (1996), all of which are incorporated herein by reference.

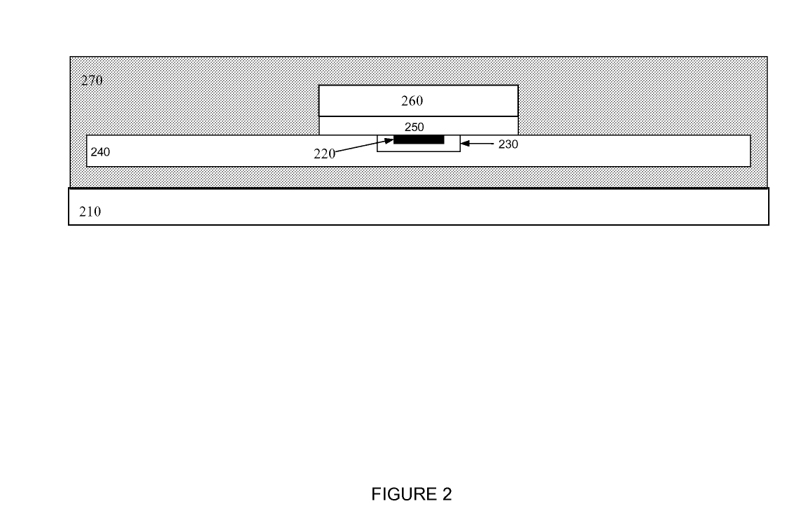

Turning now to FIG. 2, illustrated is a block diagram of an embodiment of an RFID tag constructed according to the principles of the present invention. The RFID tag is affixed or applied to a host material (e.g., a host material including a metal surface or a metal object) 210 and includes an integrated circuit 220 (including memory and a processor) located or embodied in a carrier 230 coupled to an antenna 240. An adhesive 250 is coupled to (e.g., located above and proximate) the carrier 230 and a strain relief member 260 is located above and proximate (e.g., bonded) to the adhesive 250. More particularly, the strain relief member 260 is coupled to the adhesive 250 on a surface opposite the integrated circuit 220 and the carrier 230. In the illustrated embodiment, the adhesive 250 and the strain relief member 260 cover a surface area of the integrated circuit 220 and the carrier 230. The strain relief member 260 provides strain relief for the integrated circuit 220 when the RFID tag is subject to mechanical stress such as compressive or expansive forces. Additionally, the strain relief member 260 may be formed from a temperature resistive material (e.g., a heat resistive material). The RFID tag is encapsulated by an encapsulant 270, which is coupled to and provides an offset for the RFID tag in relation to the host material 210.

As an example, consider the use of ultra high frequency (“UHF”) RFID readers and tags, which typically have an approximate read range of 5 to 10 meters. Of course, the broad scope of the present invention contemplates all types of radio frequency tags as well as general improvements in RFID tag design and detection. All of the different RFID readers may have different read ranges (lobe sizes), but the RFID system described herein may be applied to any type of RFID reader and tag.

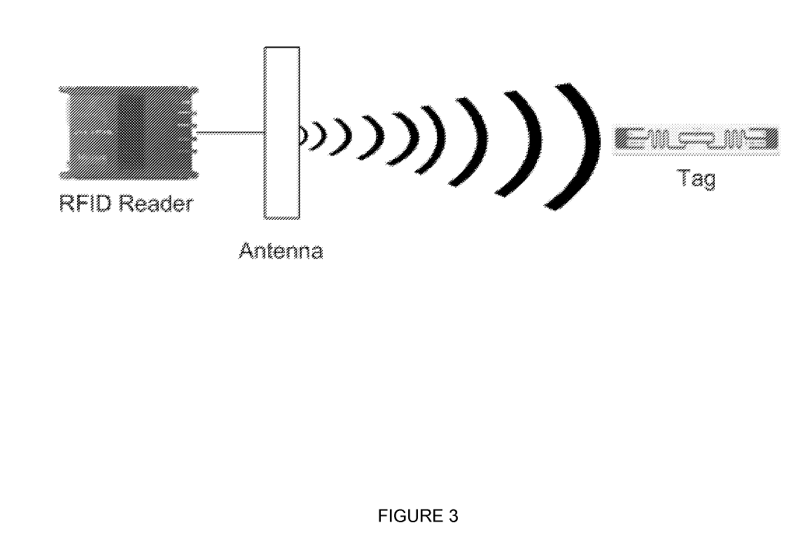

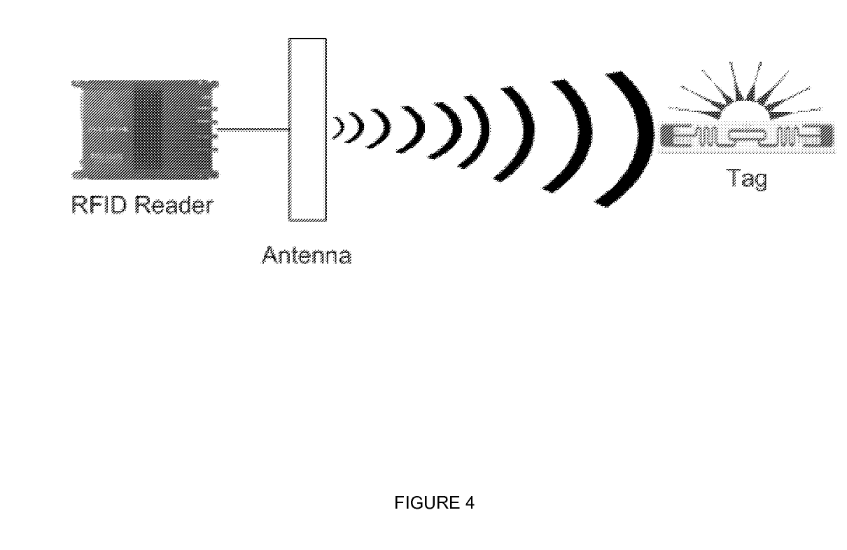

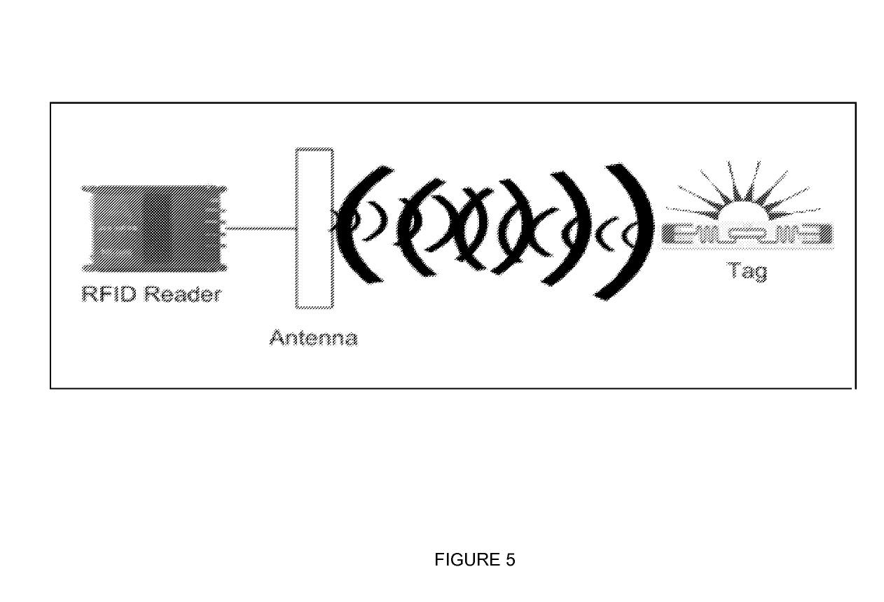

Turning now to FIGS. 3 to 6, illustrated are diagrams demonstrating exemplary principles of RFID systems in accordance with the principles of the present invention. The basic principle of RFID readers and tags is detecting a signal that is transmitted by an active RFID tag, or returned or reflected by a semi-active or passive RFID tag. When the RFID tag “response” occurs in the lobe of an RFID reader, the RFID tag is said to have been “read” by the reader. Oftentimes, the RFID reader may initiate or interrogate the lobe by transmitting a carrier signal to “see” if there are RFID tags present (via the RFID tag responses). The RFID reader interrogates the lobe for RFID tags (FIG. 3) and the RFID tag modulates the carrier signal from the RFID reader (FIG. 4). The RFID tag then responds by returning the modulated carrier signal (FIG. 5).

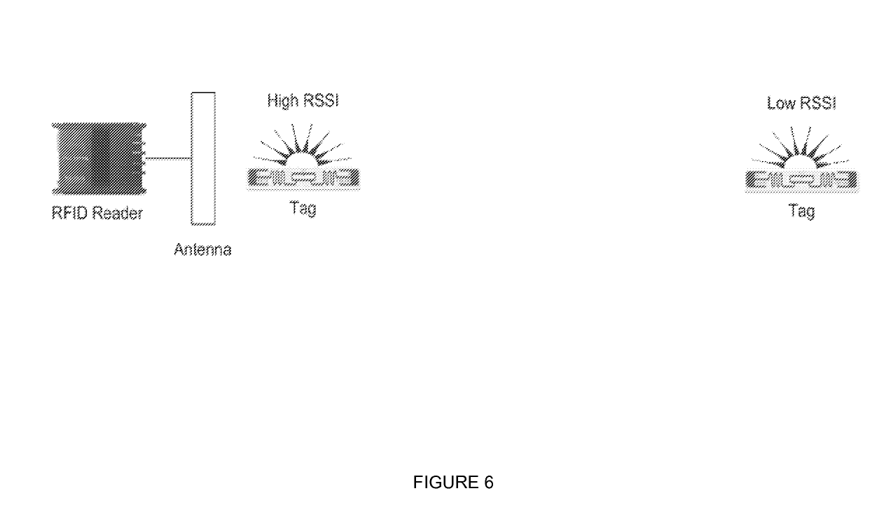

The energy with which the RFID tag responds is finite, and many RFID readers may indicate a delta index such as the received signal strength indication (“RSSI”) in some form or another. This may be displayed as RSSI, reads per second, time differential of arrival (“TDOA”), or any other indication, but all are indices of signal strength or distance indication of the RFID tag from the RFID reader/antenna. The higher the RSSI, the stronger the RFID tag response is which implies that it is closer to the RFID reader and antenna than a low RSSI value as illustrated in FIG. 6. In TDOA applications, the greater the time differential of arrival of the received signal versus the departure of the transmit signal indicates a greater distance between the RFID tag and the RFID reader and antenna.

In the event that the particular RFID reader does not have, for instance, an RSSI indicator/feedback, one can be added to measure the RSSI on behalf of the RFID reader. This does not impact the functionality as described herein as the RSSI can be obtained from an RFID reader or from a readily available RSSI measurement device attached to the RFID reader. The above embodiment described with respect to FIGS. 3 to 6 are examples of passive RFID reader and tag systems, but those skilled in the art comprehend that the same principles apply to active RFID systems and are not limited to passive RFID systems.

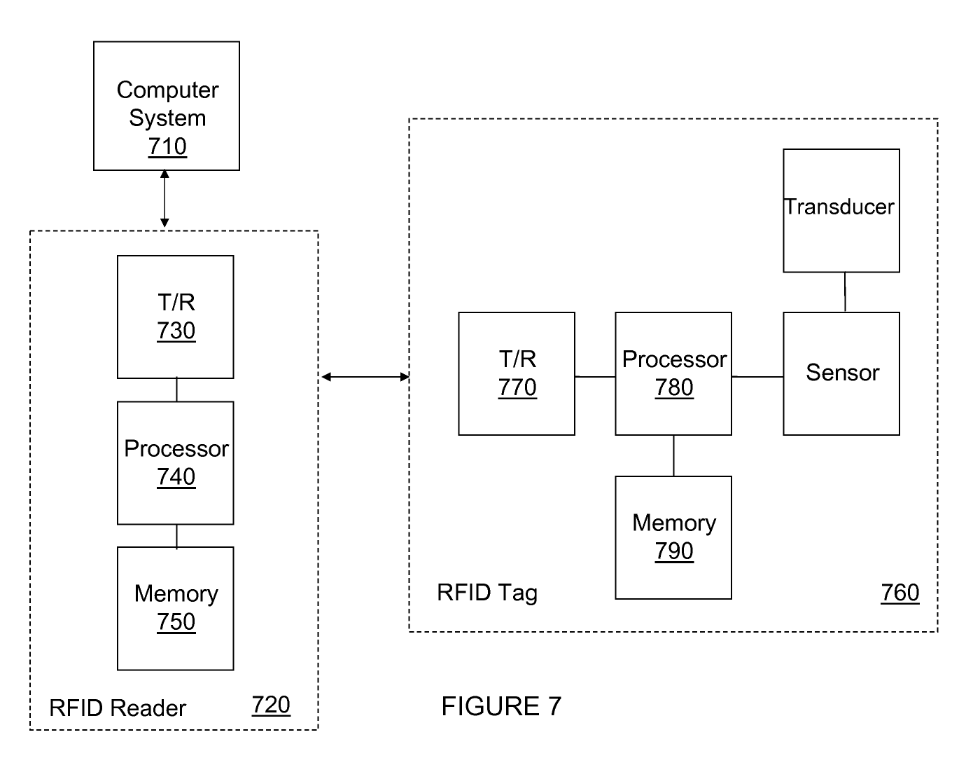

Turning now to FIG. 7, illustrated is a block diagram of an embodiment of an RFID reader in communication with an RFID tag according to the principles of the present invention. A computer system 710 directs the RFID reader 720 to read RFID tag(s) 760 located on a product. A transmitter/receiver 730 of the RFID reader 720 transmits a carrier signal to the RIFD tag 760 and detects a signal representing the RFID tag 760 from a transmitter/receiver 770 thereof. A processor 740 of the RFID reader 720 compares a delta index from the signal to a threshold to determine when the RFID tag 760 is moving. A memory 750 of the RFID reader 720 stores instructions for the processor 740 and results processed thereby. In an analogous fashion, the transmitter/receiver 770 of the RFID tag 760 receives the carrier signal from the RFID reader 720, processes the carrier signal with the processor 780, and provides a signal (e.g., a returned, modulated carrier signal) from the RFID tag 760 via the transmitter/receiver 770 to the RFID reader 720. A memory 790 of the RFID tag 760 stores or includes information such as instructions, RFID tag identification, a parameter profile of the product, and results in the form of processed data and otherwise.

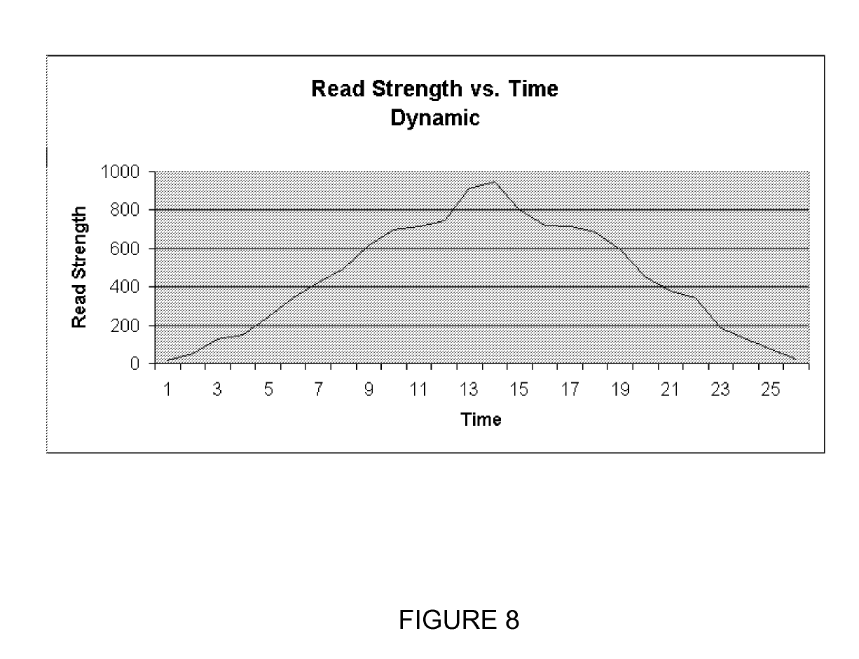

As RFID tags move through an RFID lobe or field associated with the RFID reader, the delta indices (e.g., RSSI values) vary for those RFID tags that are in motion. Stationary RFID tags will have varying RSSI values, but their variances will be significantly less than that of those in motion. In accordance therewith, FIG. 8 illustrates a graph of an exemplary read strength response of an RFID tag moving through an RFID reader/antenna field in accordance with the principles of the present invention. In particular, FIG. 8 illustrates a plot of read strength verses time for an RFID tag moving unobstructed through an RFID portal.

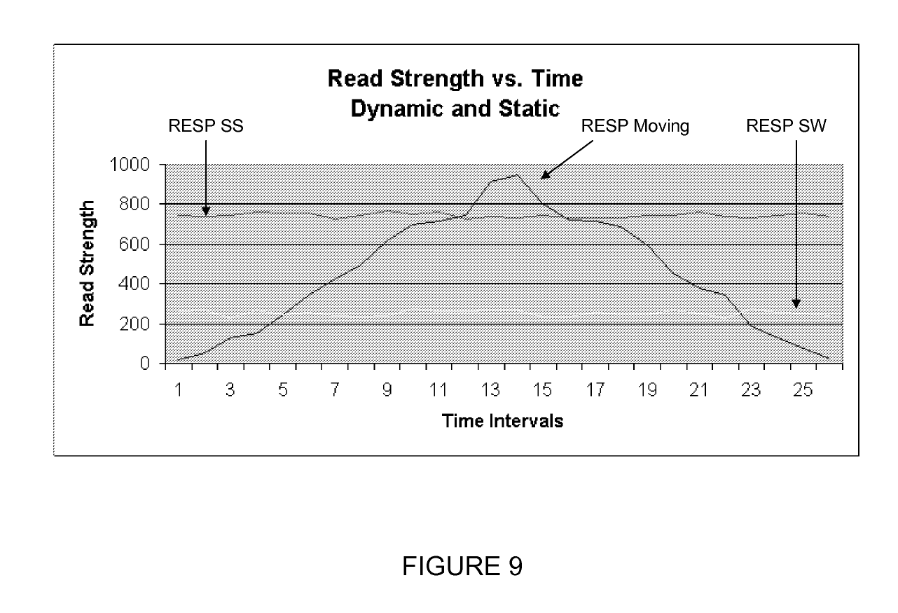

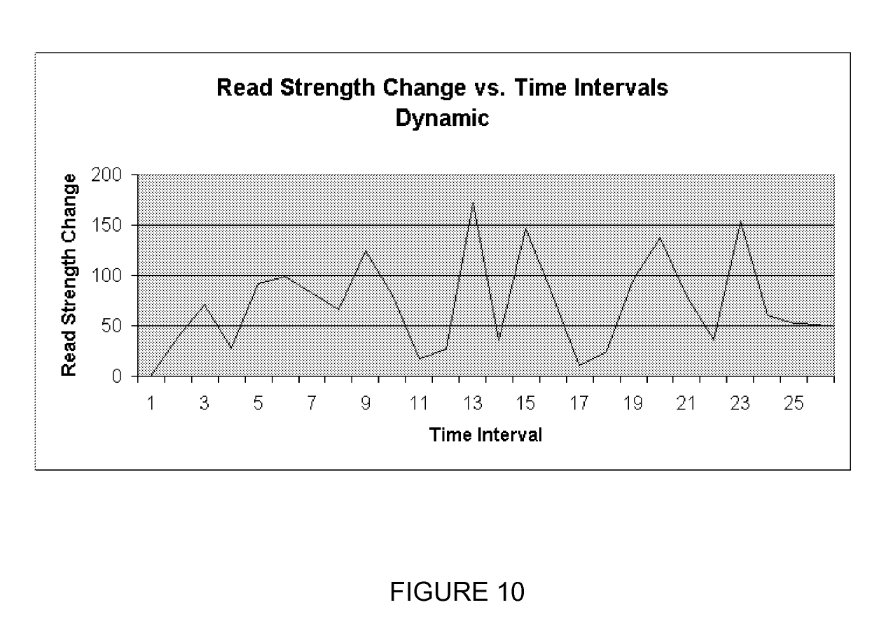

Turning now to FIG. 9, illustrated is a graph of an exemplary read strength response of an RFID tag moving (designated “RESP moving”) through and stationary RFID tags (one near/strong response designated “RESP SS” and one far/weak response designated “RESP SW”) in an RFID reader/antenna field in accordance with the principles of the present invention. As there can be static RFID tags both near and far from the antenna(s), the delta indices such as the RSSI value alone may not be sufficiently indicative of RFID tags in motion (unobstructed). Since there could be static RFID tags close to antennas while there are other products in motion, the RFID system may process the changes in RSSI values over a number or read strength/time intervals. For the RFID tags in motion, the RSSI values will change significantly while the stationary RFID tags will have minimal change in the RSSI values over time. In accordance therewith, FIG. 10 illustrates a graph demonstrating changes in read strength for a sample RFID tag in motion in accordance with the principles of the present invention. This is similar to taking a first derivative of RFID tag responses illustrated with respect to FIG. 8.

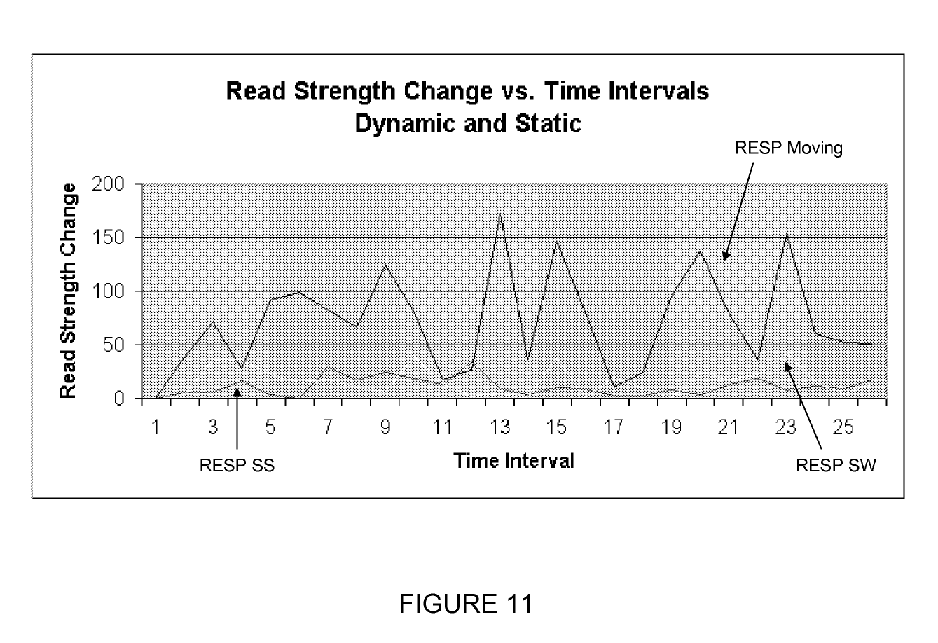

Turning now to FIG. 11, illustrated is a graph superimposing static RFID tag changes in RSSI (one near/strong response designated “RESP SS” and one far/weak response designated “RESP SW”) with a first derivative of an RFID tag in motion (designated “RESP moving”) in accordance with the principles of the present invention. The illustrated embodiment clearly distinguishes between moving and stationary RFID tags. Based on the above exemplary illustrations, a measurement of changes in RSSI values for RFID tag reads, coupled with additional processing where necessary, could be used to determine the interesting RFID tag values (e.g., the RFID tags in motion). Using a configurable threshold value, for example, 50 in the above example, for changes in the RSSI values, this would substantially eliminate the extraneous reads, and isolate the read of the RFID tag that is in motion (as its changes in RSSI values are in excess of the threshold).

The threshold may be automatically set mathematically through a series of calculations. By calculating the variance of the changes in the RFID tag responses, the variances could be grouped to differentiate between high and low variances for moving or stationary RFID tag signatures. The maximum variance of the low signatures could be used, and the “interesting read” threshold could be set at a +3 or +4 sigma level above the maximum variance level of the RSSI to make the RSSI threshold level setting automatic.

The calculations employed by the processor of the RFID reader could employ near real time processing of the raw data from the RFID readers employing such techniques as Corner Turning Memory as an example. This data may be analog or converted to digital processing based on the need for the application. The RFID system also comprehends that there may be environmental conditions that may vary, and it incorporates embodiments that may use environmental processing as a way to account for noise floors dynamically, for example.

The illustrations and examples used here are exemplary embodiments, and those skilled in the art of RFID understand that this method could be applied to many reader types. In addition, those skilled in the art of RFID understand that the threshold may be varied (configurable) before a read is “qualified” as interesting or significant.

It should be understood that sources of errors may be present in the form of variance of delta indices such as the RSSI as well as obstructions. As illustrated with respect to FIG. 9, even stationary RFID tags have some RSSI variance, and that error is addressed via measuring the changes in RSSI and applying a threshold to the first derivative to differentiate between stationary and moving RFID tags.

Additional errors may be introduced into the RFID system. For instance, if a radio frequency obstruction like a forklift or an individual passes between the RFID reader/antenna and a stationary RFID tag, the static tag response may exhibit large changes in delta indices such as RSSI as the obstruction would create a barrier to the radio frequency response (absorbing or distorting the energy). Many RFID readers have antennas on either side of an RFID portal to substantially eliminate this error, but for the sake of completeness, this error source should be addressed.

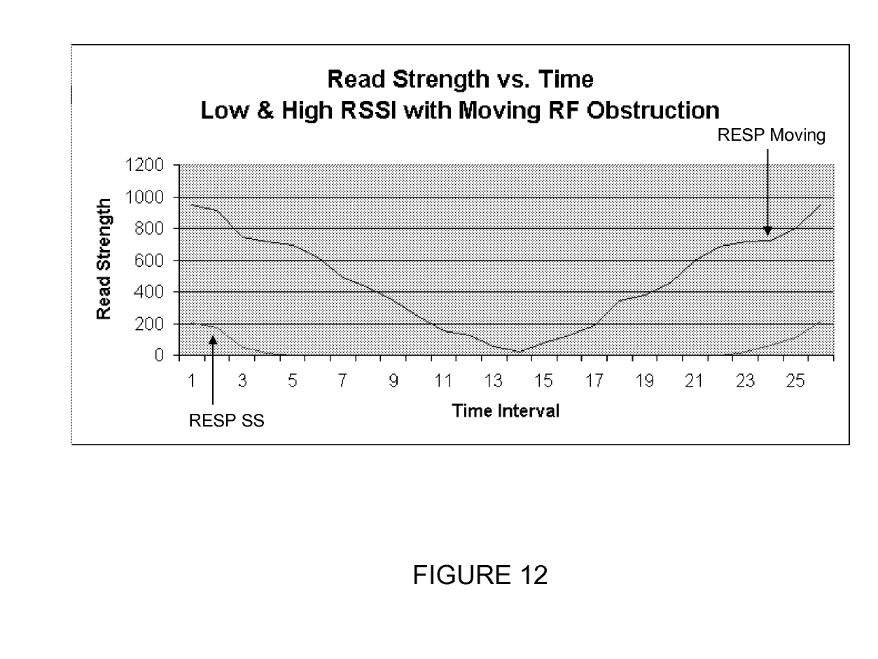

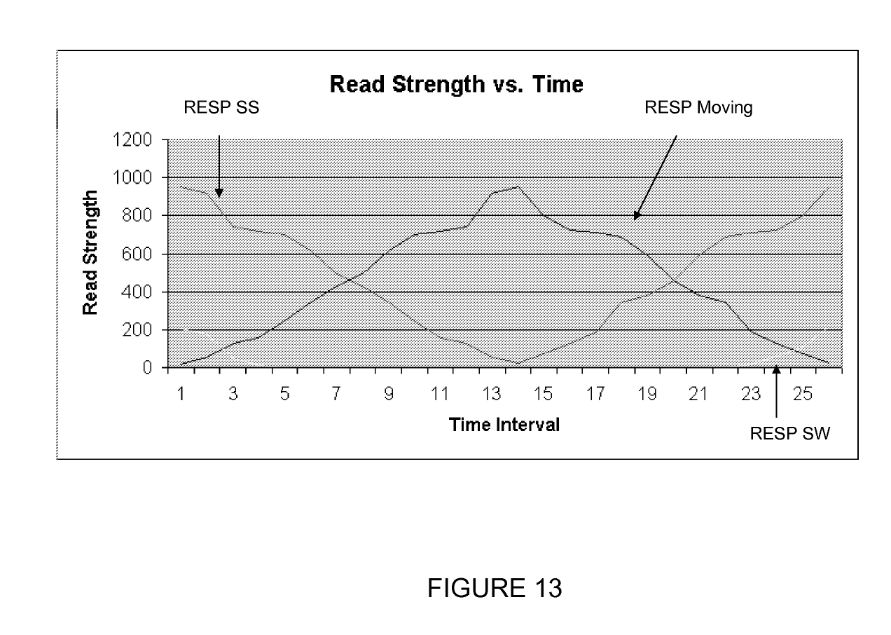

Turning now to FIGS. 12 and 13, illustrated are graphs of an exemplary read strength verses time for an RFID tag having a low RSSI and a high RSSI with a radio frequency obstruction in accordance with the principles of the present invention. In the illustrated embodiment, the static RFID tag responses provide a low RSSI (one near/strong response designated “RESP SS” and one far/weak response designated “RESP SW”) and the RFID tag in motion provides a high RSSI (designated “RESP moving”). Note that the RFID tag having the low RSSI is obstructed to the point that the response is undetectable (RSSI=0). So, over multiple time intervals of a data sampling, the RFID system could have a minimum with obstructions moving between the RFID tag and reader/antenna. The RFID tag having the high RSSI is still readable, but note that the read strength starts high, reduces in the presence of the obstruction, and then returns to the higher level. This is the inverse of a normal RFID tag in motion moving through an RFID portal. FIG. 13 illustrates a graph with the RFID tags' responses superimposed.

Since the RSSI signatures over time have opposite concavities (convex/concave), a second derivative could be employed to quickly differentiate between static or moving RFID tags as the second derivative is used to determine concavity. Another possibility is to look for the low-high-low (“LHL”) signature (digital) for moving RFID tags (concave). If an RSSI response has a LHL response, then the RFID tag is moving. If the response is a high-low-high (“HLH”) signature (convex or also known as concave up), then the RFID tag is stationary and its read intervals were obstructed as illustrated in FIG. 13.

Thus, an RFID reader, system and method of operating the same has been introduced herein. In one embodiment, the RFID reader includes an antenna and a transmitter/receiver configured to transmit a carrier signal and detect a signal representing a returned, modulated carrier signal from the RFID tag. The RFID reader also includes a processor configured to compare a delta index (e.g., a derivative thereof) from the signal to a threshold to determine when the RFID tag is moving. The signal is typically within a lobe of the RFID reader depending on a frequency and power levels employed by the RFID reader. The threshold may be selected for an RFID tag in motion or above a level for a stationary RFID tag, or selected above a variance level for a delta index such as a received signal strength indication for an RFID tag in motion or above a level for a stationary RFID tag. The threshold may also be a pre-selected fixed threshold or a dynamically selected threshold in real time. The delta indices may be selected from a received signal strength indication, reads per second, and time differential of arrival. In addition, the delta indices may provide a low-high-low response or a high-low-high response, especially in a presence of an obstruction.

For a better understanding of RFID technologies, in general, see “RFID Handbook,” by Klaus Finkenzeller, published by John Wiley & Sons, Ltd., 2nd edition (2003), which is incorporated herein by reference. For a better understanding of RFID tags in compliance with the EPC, see “Technical Report 860 MHz-930 MHz Class I Radio Frequency Identification Tag Radio Frequency & Logical Communication Interface Specification Candidate Recommendation,” Version 1.0.1, November 2002, promulgated by the Auto-ID Center, Massachusetts Institute of Technology, 77 Massachusetts Avenue, Bldg 3-449, Cambridge Mass. 02139-4307, which is incorporated herein by reference. For a better understanding of conventional RFID readers, see the following RFID readers, namely, “MP9320 UHF Long-Range Reader,” provided by SAMSys Technologies, Inc. of Ontario, Canada, “MR-1824 Sentinel-Prox Medium Range Reader,” by Applied Wireless ID of Monsey, N.Y. (see also U.S. Pat. No. 5,594,384 entitled “Enhanced Peak Detector,” U.S. Pat. No. 6,377,176 entitled “Metal Compensated Radio Frequency Identification Reader,” U.S. Pat. No. 6,307,517 entitled “Metal Compensated Radio Frequency Identification Reader”), “2100 UAP Reader,” provided by Intermec Technologies Corporation of Everett, Wash. and “ALR-9780 Reader,” provided by Alien Technology Corporation of Morgan Hill, Calif., all of which are incorporated by reference.

Furthermore, for a better understanding of standards base work regarding RFID, see the EPCglobal standards and related publications, namely, EPCglobal release EPC Specification for Class 1 Gen 2 RFID Specification, December 2004, and a “Whitepaper: EPCglobal Class 1 Gen 2 RFID Specification,” published by Alien Technology Corporation, Morgan Hill, Calif. (2005). For a better understanding of RFID devices, see U.S. Pat. No. 6,853,087, entitled “Component and Antennae Assembly in Radio Frequency Identification Devices,” to Neuhaus, et al., issued Feb. 8, 2005. For related applications, see U.S. Patent Application Publication No. 2006/0212141, entitled “Radio Frequency Identification-Detect Ranking System and Method of Operating the Same,” Abraham, Jr., et al., published Sep. 21, 2006, U.S. Patent Application Publication No. 2006/0212164, entitled “Radio Frequency Identification Application System,” to Abraham, Jr., et al., published Sep. 21, 2006, U.S. Patent Application Publication No. 2007/0229284, entitled “Radio Frequency Identification Tag and Method of Forming the Same,” to Svalesen, et al., published Oct. 4, 2007, and U.S. patent application Ser. No. 11/876,978, entitled “Asset Including a Radio Frequency Identification Tag and Method of Forming the Same, to Svalesen, et al., filed Oct. 23, 2007. The aforementioned references, and all references herein, are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the materials and structures discussed above can be implemented in different materials and structures to advantageously form an RFID system as described herein.

Moreover, the scope of the present application is not intended to be limited to the particular embodiments of the process, machine, manufacture, composition of matter, means, methods and steps described in the specification. As one of ordinary skilled in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A radio frequency identification (RFID) reader, comprising:
a transmitter/receiver configured to detect a signal representing an RFID tag; and
a processor configured to compare a delta index from said signal to a threshold to determine when said RFID tag is moving.

2. The RFID reader as recited in claim 1 wherein said transmitter/receiver is configured to transmit a carrier signal and said signal represents a returned, modulated carrier signal from said RFID tag.

3. The RFID reader as recited in claim 1 wherein said RFID reader comprises an antenna, coupled to said transmitter/receiver, configured to receive said signal.

4. The RFID reader as recited in claim 1 wherein said signal is within a lobe of said RFID reader.

5. The RFID reader as recited in claim 1 wherein said signal is within a lobe of said RFID reader depending on a frequency and power levels employed by said RFID reader.

6. The RFID reader as recited in claim 1 wherein said processor is configured to compare a derivative of said delta index from said signal to said threshold to determine when said RFID tag is moving.

7. The RFID reader as recited in claim 1 wherein said delta index is selected from the group consisting of:
a received signal strength indication,
reads per second, and
time differential of arrival.

8. The RFID reader as recited in claim 1 wherein said delta index provides a low-high-low response or a high-low-high response.

9. The RFID reader as recited in claim 1 wherein said threshold is a pre-selected fixed threshold.

10. The RFID reader as recited in claim 1 wherein said threshold is dynamically selected in real time.

11. A method of operating a radio frequency identification (RFID) reader, comprising:
detecting a signal representing an RFID tag; and
comparing a delta index from said signal to a threshold to determine when said RFID tag is moving.

12. The method as recited in claim 11 further comprising transmitting a carrier signal and said signal represents a returned, modulated carrier signal from said RFID tag.

13. The method as recited in claim 11 wherein said signal is within a lobe of said RFID reader depending on a frequency and power levels employed by said RFID reader.

14. The method as recited in claim 11 wherein said comparing includes comparing a derivative of said delta index from said signal to said threshold to determine when said RFID tag is moving.

15. The method as recited in claim 11 wherein said delta index is selected from the group consisting of:
a received signal strength indication,
reads per second, and
time differential of arrival.

16. A radio frequency identification (RFID) system, comprising:
an RFID tag; and
an RFID reader, including:
an antenna,
a transmitter/receiver, coupled to said antenna, configured to transmit a carrier signal and detect a signal representing a returned, modulated carrier signal from said RFID tag, and
a processor configured to compare a delta index from said signal to a threshold to determine when said RFID tag is moving.

17. The RFID system as recited in claim 16 wherein said signal is within a lobe of said RFID reader depending on a frequency and power levels employed by said RFID reader.

18. The RFID system as recited in claim 16 wherein said processor is configured to compare a derivative of said delta index from said signal to said threshold to determine when said RFID tag is moving.

19. The RFID system as recited in claim 16 wherein said delta index is selected from the group consisting of:
a received signal strength indication,
reads per second, and
time differential of arrival.

20. The RFID system as recited in claim 16 wherein said delta index provides a low-high-low response or a high-low-high response.
